(19) United States
(12) Patent Application Publication
(10) Pub. No.: US 2006/0244991 A1
(43) Pub. Date: Nov. 2, 2006

(54) Image processing device, image processing method, and computer readable recording medium stored with image processing program

(75) Inventors: Gonchigzeveg Tenger, Yokohama-shi (JP); Hiroshi Kato, Sagamihara-shi (JP); Takahiro Fukuhara, Yokosuka-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/222,742

(22) Filed: Sep. 12, 2005

(30) Foreign Application Priority Data
Apr. 28, 2005 (JP) 2005-133718

(51) Int. Cl. G06F 3/12

(52) U.S. Cl. 358/1.15; 358/448

(57) ABSTRACT

An image processing device includes a communication unit for communicating with another image processing device; and a controller for making a judgment based on information concerning a print job on the other image processing device obtained through the communication unit as to whether it is preferable or not to execute the print job on its own image processing device rather than to execute the print job on the other image processing device, and transferring the print job from the other image processing device to its own image processing device depending on the judgment result.

This application is based on Japanese Patent Application No. 2005-133718 filed on Apr. 28, 2005, the contents of which are hereby incorporated by reference.

### BACKGROUND OF THE INVENTION

1. Field of the Invention

The present invention relates to an image processing device, an image processing method, and a computer readable recording medium stored with an image processing program. The invention relates to, in particular, an image processing device capable of communicating with other image processing devices through a network, an image processing method using the particular image processing device, and a computer readable recording medium stored with an image processing program for controlling the particular image processing device.

2. Description of the Related Art

In a system having a plurality of printers connected to a network, a print job prepared by a client terminal is sent to and executed on a specified printer.

In such a system, however, a concentration of workloads arising from print jobs may occur on a certain printer. Under such a circumstance, the processing capability of the system as a whole cannot be optimized.

As a solution to such a problem, a technology has been disclosed in which a workstation, which functions as a master computer, identifies the load condition of each printer, and shifts print jobs of heavily loaded printers to printers with lighter work loads when there is an unbalance of loads among the printers (Unexamined Publication No. JP-A-5-265777). Another technology is disclosed in which each server connected to each printer transfers a print job that the server received to another server, when the server judges that the job cannot be executed efficiently by it (Unexamined Publication No. JP-A-9-179833). Thus, these technologies make it possible to distribute loads on a plurality of printers to equalize loads among the printers.

However, in those technologies disclosed by the Unexamined Publications described above, the master computer (or server) itself, which is already heavily loaded with print jobs, has to bear the task of controlling print job transfers. Therefore, the master computer's load further increases and may present itself a bottleneck of the entire process. Thus, there was a problem of not being able to execute load distribution more efficiently. Moreover, although it is possible to plan to have a separate device for allocating print jobs to lightly loaded printers, such an additional device requires an additional space, which all together results in an increase of the equipment cost.

### OBJECTS AND SUMMARY

It is an object of the present invention to provide an image processing device, an image processing method, and a computer readable recording medium stored with an image processing program, which are all improved for solving the abovementioned problems.

Another object of the invention is to provide an image processing device capable of efficiently distributing loads arising from print jobs among a plurality of printers, an image processing method using said image processing device, and a computer readable recording medium stored with an image processing program for controlling said image processing device.

According to an embodiment of the invention, there is provided an image processing device capable of communicating with another image processing device via a network, comprising: a communication unit for communicating with the other image processing device; and a controller for making a judgment based on information concerning a print job on the other image processing device obtained through the communication unit as to whether it is preferable or not to execute the print job on its own image processing device rather than to execute the print job on the other image processing device, and transferring the print job from the other image processing device to its own image processing device depending on the judgment result.

According to another embodiment of the invention, there is provided an image processing method using an image processing device capable of communicating with another image processing device via a network, comprising the steps of: 1) receiving information concerning a print job on the other image processing device from the other image processing device; 2) making a judgment based on the information received in the step 1) as to whether it is preferable to execute the print job on its own image processing device rather than to execute the print job on the other image processing device; and 3) controlling to transfer the print job from the other image processing device to its own image processing device depending on the judgment result in the step 2).

According to a further embodiment of the invention, there is provided a computer readable recording medium stored with an image processing program for controlling an image processing device capable of communicating with another image processing device via a network, said image processing program causing the image processing device to execute a process comprising the steps of: 1) receiving information concerning a print job on the other image processing device from the other image processing device; 2) making a judgment based on the information received in the step 1) as to whether it is preferable to execute the print job on its own image processing device rather than to execute the print job on the other image processing device; and 3) controlling to transfer the print job from the other image processing device to its own image processing device depending on the judgment result in the step 2).

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 is an overall constitutional diagram of a printing system having printers according to an embodiment of the present invention.

FIG. 2 is a block diagram showing the schematic constitution of a printer.

FIG. 3 is a diagram for describing a printer information table, a job queue, a network control unit, a job control unit, and a main control unit.

FIG. 4 is a flowchart showing the sequence of the registration process for the printer information table.

FIG. 5 shows an example of the printer information table.

FIG. 6 is a flowchart showing the sequence of the process for determining the printer reference priority order.

FIG. 7 is a diagram showing the printer information table indicating the estimated cumulative processing time and the printer reference priority order.

FIG. 8 shows an alternative example of the printer information table.

FIG. 9 shows another alternative example of the printer information table.

FIG. 10 shows yet another alternative example of the printer information table.

FIG. 11 shows yet another alternative example of the printer information table.

FIG. 12 shows yet another alternative example of the printer information table.

FIG. 13 shows yet another alternative example of the printer information table.

FIG. 14 shows yet another alternative example of the printer information table.

FIG. 15 shows yet another alternative example of the printer information table.

FIG. 16 is a flowchart showing the sequence of the process for the print job transfer control.

FIG. 17 is a flow chart, continuing from FIG. 16, showing the sequence of the process for the print job transfer control.

FIG. 18 is a diagram showing an example of job queue control data.

FIG. 19 is a flowchart showing the sequence of the process for dealing with a fault when it occurs.

FIG. 20 is a flowchart showing the sequence of the process for notifying the printer's process information.

FIG. 21 shows an example of the printer location information table.

FIG. 22 is a diagram showing an example of the notification window.

### DETAILED DESCRIPTION OF PREFERED EMBODIMENTS

The embodiment of this invention will be described below with reference to the accompanying drawings.

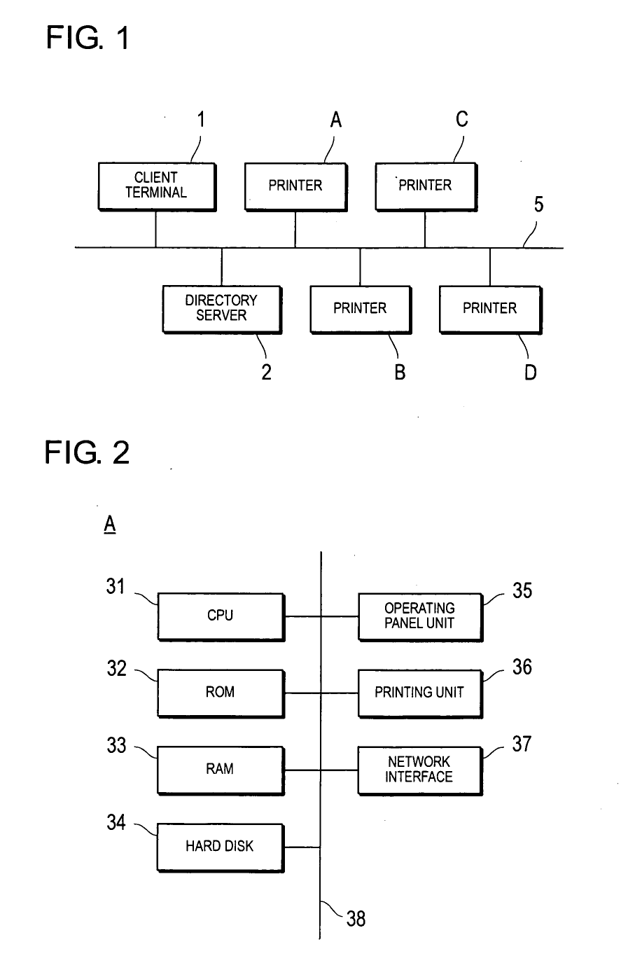

FIG. 1 is an overall constitutional diagram of a printing system having printers according to an embodiment of the present invention. The printing system is equipped with printers A through D, provided as the image processing devices, a client terminal 1, and a directory server 2, all of which are communicably interconnected with each other via a network 5. The network 5 can be a LAN connecting computers and network equipment according to standards such as Ethernet®, Token Ring, and FDDI, or a WAN that consists of several LANs connected by a dedicated line.

The types and the number of equipment to be connected to the network 5 are not limited to those shown in FIG. 1. For example, although four printers are connected to the network 5 in this embodiment, an arbitrary number of printers, not limited to the quantity 4, can be connected to the network 5.

The client terminal 1 is a general purpose PC (personal computer) and is capable of preparing and sending print jobs to any of the printers A through D, for example.

The director server 2 stores resources on the network and their attributes and provides a directory service that makes it possible to search them. The resources here are meant to be information about users and organizations that use the network, usable services provided by the server, and usable equipment such as printers. LDAP (Lightweight Directory Access Protocol) is a standard protocol used for accessing to the directory service.

FIG. 2 is a block diagram showing the schematic constitution of the printer A. Since the printers B, C and D have similar constitutions as the printer A, their descriptions are omitted.

The printer A has a CPU 31, a ROM 32, a RAM 33, a hard disk 34, an operating panel unit 35, a printing unit 36, and a network interface 37, all of which are interconnected with each other via a bus 38 for exchanging signals.

The CPU 31 controls various parts indicated above and executes various arithmetic processes according to a program. The ROM 32 stores various programs and data in advance. The RAM 33 stores programs and data temporarily as a working area. The hard disk 34 stores various programs including an operating system and data.

The operating panel unit 35 is used for displaying various kinds of information and for entering various instructions. The printing unit 36 prints image data on a recording medium such as paper using a known imaging process such as the electronic photographing process including such processes as electrical charging, exposure, developing, transferring and fixing.

The network interface 37 is typically a LAN card and is used for communicating with external equipment via the network 5.

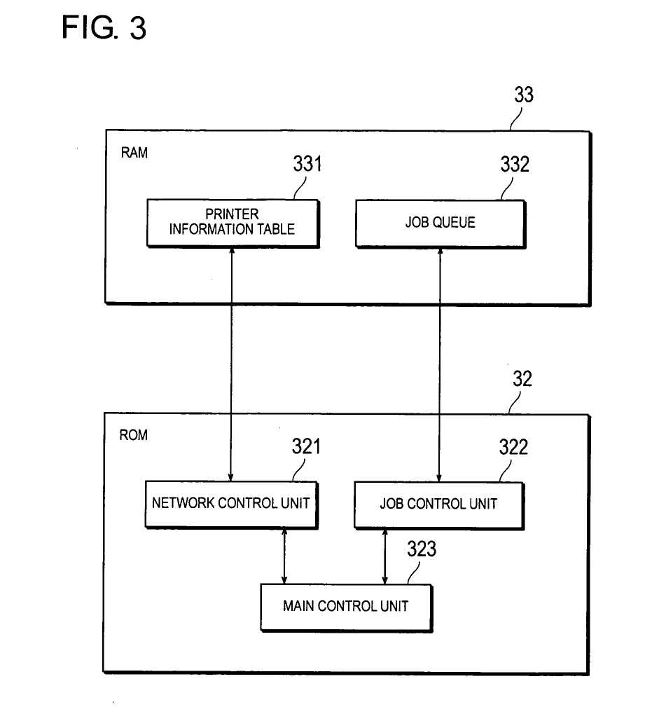

As shown in FIG. 3, the RAM 33 has areas assigned respectively for a printer information table 331 and a job queue 332. The printer information table 331 stores information concerning other printers on the network 5 or under the control of the directory server 2. The job queue 332 stores the received print jobs.

The ROM 32 has areas assigned respectively for storing programs corresponding to a network control unit 321, a job control unit 322, and a main control unit 323. The network control unit 321 detects other printers, and registers the detected information of those other printers on the printer information table 331. The job control unit 322 is in charge of controlling the job queue 332 and transfer control of print jobs. The main control unit 323 is in charge of overall control. The functions of the network control unit 321, the job control unit 322, and the main control unit 323 are performed by the CPU 31 as it reads out corresponding programs to the RAM 33 and executes them. In other words, each control unit's function is achieved by a cooperation between the CPU 31, the ROM 32, and the RAM 33.

The printer A may contain constitutional elements other than those described above, or may not include a portion of the abovementioned elements.

Next, the printer A's operation is described as an example below.

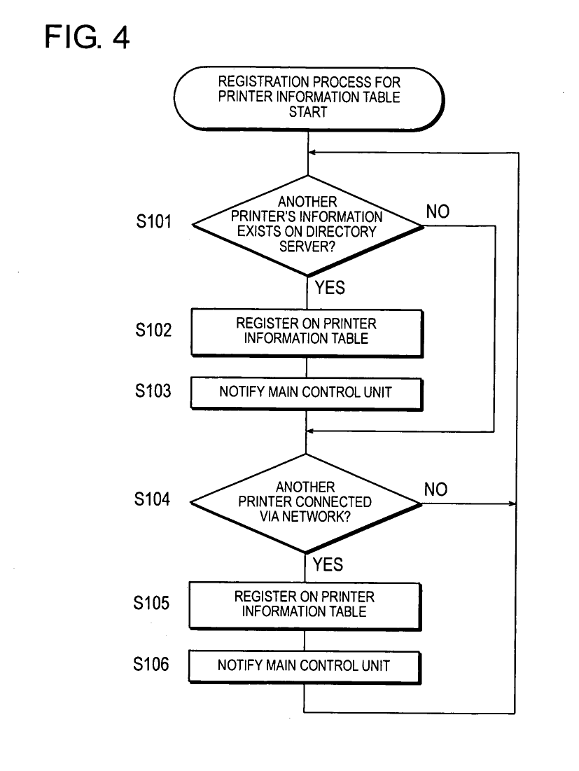

FIG. 4 is a flowchart showing the sequence of the registration process for the printer information table. The algorithm shown in the flowchart of FIG. 4 is stored as a program in the ROM 32 of the printer A and executed by the CPU 31. The process of FIG. 4 is executed by the network control unit 321 in this embodiment. This process is implemented when the printer A is connected to the network 5 or at a fixed time interval.

First, a judgment is made as to whether information concerning another printer exists in the directory server 2 (S101). The network control unit 321 inquires the directory server 2 about information concerning another printer.

If it is judged that the information concerning another printer exists in the directory server 2 (S101: Yes), said information is obtained and registered to the printer information table 331 (S102), while the main control unit 323 will be notified of it (S103). On the other hand, if it is judged that the information concerning another printer does not exist in the directory server 2 (S101: No), the program advances to the step S104.

In the step S104, a judgment is made as to whether another printer is connected to the printer A via the network 5. At this point, the network control unit 321 broadcasts to each device on the network 5 an inquiry whether it is a printer connected to the network 5 or not.

If it is judged that another printer is connected to the printer A via the network 5 (S104: Yes), information concerning the other printer is obtained and registered to the printer information table 331 (S105), while the main control unit 323 will be notified of it (S106). On the other hand, if it is judged that another printer is not connected to the printer A via the network 5 (S104: No), the program returns to the step S101.

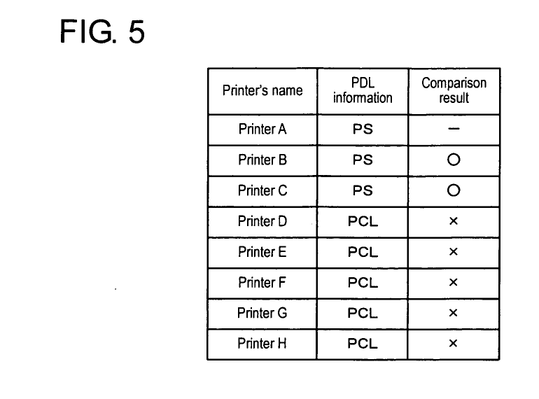

FIG. 5 shows an example of the printer information table. In case of FIG. 5, the specification of a printer is obtained as the information concerning the printer. The specification of a printer here means information specific to the particular printer that does not depend on the processing status of a print job, such as the functions, performances, characteristics, and installed location of the printer. The specification of a printer obtained here is PDL (page description language) information that can be analyzed by the printer. The information concerning printers E through H is obtained from the directory server 2.

For example, the PDL information of the printers A through C is PS (PostScript®) and the PDL information of the printer D through H is PCL (Printer Control Language) according to FIG. 5.

The network control unit 321 compares the specification of its own printer A with the specification of another printer to obtain the degree of matching between the specifications of the two printers and register it to the comparison result item of the printer information table. The degree (%) of matching of the specifications indicates the probability of being able to execute on its own printer A print jobs that can be executed on the other specific printer. In the comparison result item of the printer information table as shown in FIG. 5, “◯” denotes that the degree of matching is greater than zero, while “x” denotes that the degree of matching is zero. Incidentally, although the description concerning its own printer A is shown in FIG. 5, it can be omitted.

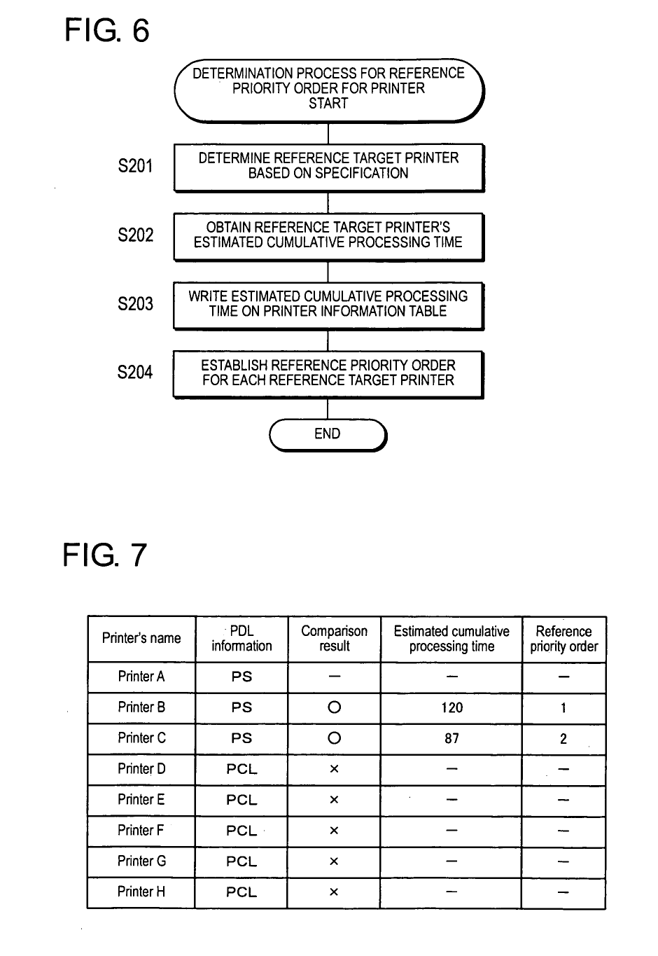

Next, the sequence of the process for determining the printer reference priority order will be described below with reference to FIG. 6. The algorithm shown in the flowchart of FIG. 6 is stored as a program in the ROM 32 of the printer A and executed by the CPU 31. The process of FIG. 6 is executed by the network control unit 323 in this embodiment. This process is executed when the printer A's workload is below a certain level, for example, if there is not print job within the job queue 332, or the estimated cumulative processing time, which will be discussed later, is below a certain level.

First, a reference target printer is determined, which is to be used as a reference for transferring a print job to its own printer A based on the specification (S201). Specifically, the main control unit 323 specifies those other printers having the comparison result items with “◯” as reference target printers, and eliminate those other printers having the comparison result items with “x” from the target of reference. The printers B and C whose PDL information match with that of its own printer A are determined as the reference target printers, but other printers D through H are specified as non-reference object printers and will be completely eliminated from the target of reference.

Next, the estimated cumulative processing time for a reference target printer is obtained from the particular reference target printers (S202). Each printer on the network 5 calculates the estimated time for processing each print job held in the job queue 332, and holds it as job attributive data to be discussed later. The estimated cumulative processing time is an estimated time required for executing print jobs starting from the first print job to a specified print job in the specified order of execution and calculated for each print job. Here the estimated cumulative processing time for the last print job in the execution order, i.e., an estimated time required for executing all the print jobs contained in the job queue 332, is obtained.

The estimated cumulative processing time for the particular reference target printer is recorded on the printer information table as shown in FIG. 7 (S203).

A reference priority order is assigned to each reference target printer in the descending order of the estimated cumulative processing time and the assigned reference priority order is recorded on the printer information table as shown in FIG. 7 (S204).

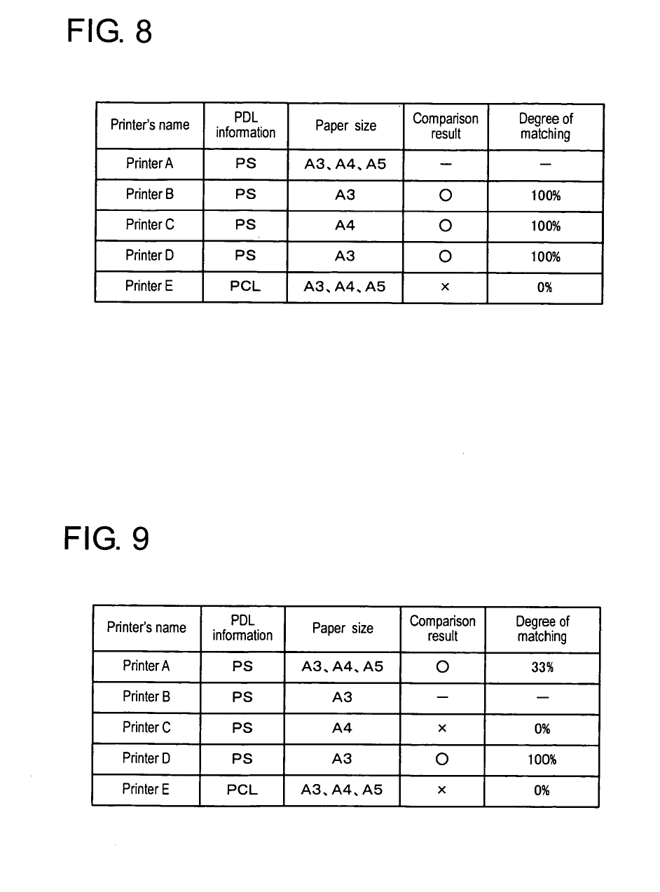

FIG. 8 shows an alternative example of the printer information table. In case of FIG. 8, the paper size is obtained as a printer specification item in addition to the PDL information. The paper size shows the size of paper that is stored in the particular printer and can be used for printing.

As shown in FIG. 8, the PDL information of the printers A through D is PS and the PDL information of the printer E is PCL. Since the printer E's PDL information is different from the printer A, the comparison result item becomes “x.” Since the printers B, C, and D share the same PDL information as the printer A and the paper size is a size that can be used on the printer A, the comparison result items become “◯.” If there is any specification item that does not match at all, the comparison result item becomes “x.”

FIG. 9 shows another alternative example of the printer information table. In case of FIG. 9, the paper size is obtained as a printer specification item in addition to the PDL information. However, FIG. 9 shows a printer information table to be stored in the printer B. The specification of each printer has the same contents as those shown in FIG. 8.

As to specifications that can be determined clearly whether they match or not between the two printers, such as the PDL information, the degree of matching is expressed as 0% (do not match) or 100% (match). On the other hand, in case of specifications that can partially match between the two printers, such as the paper size, for example, when the number of types of size of paper that can be used on a reference target printer is greater than that of its own printer, the degree of matching is calculated as a quotient calculated by dividing the number of the matching types by the sum of the numbers of matching and mismatching types.

FIG. 9 shows that the degree of matching of the printer A's PDL information relative to that of the printer B is 100%. The degree of matching of the printer A's paper size relative to that of the printer B is calculated as 1/(1+2)=0.33 (33%) since the matching paper size is only A3 size, i.e., the number of the matching size being one, while the mismatching sizes are A4 and A5, i.e., the number of the mismatching sizes being two. However, if the frequency of A3 size paper being used on the printer A can be assumed to be small, the calculation method can be modified to make it smaller than 33%. Furthermore, the calculation methods of the degree of matching for other specifications that are to be discussed later can be arbitrarily modified as well.

The total degree of matching is obtained by multiplying the matching degrees of all specification items. For example, as shown in FIG. 9, the total degree of matching of the printer A relative to the printer B is calculated as 1*0.33=0.33 (33%). Furthermore, the degree of matching for the paper size of the printer E relative to that of the printer B is 100%, but the degree of matching for the PDL information of the printer E relative to that of the printer B is 0%, the total degree of matching for the printer A relative to the printer B is calculated as 1*0=0 (0%).

In comparing a specification item such as the paper size of the two printers wherein the specifications of the two printers match only partially, it can be so arranged not just to determine whether a printer is a reference target printer or a non-reference printer based only on the comparison result items on the printer information table, but also to determine the order of reference (priority) of the reference object printers based on the degree of matching.

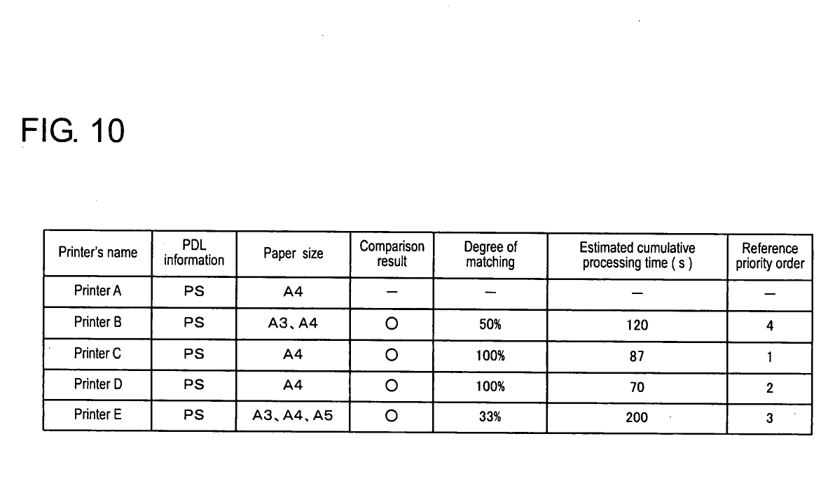

FIG. 10 shows yet another alternative example of the printer information table. In case of FIG. 10, the paper size is obtained as a printer specification item in addition to the PDL information. Furthermore, the estimated cumulative processing time of each reference target printer is recorded on the printer information table. Moreover, FIG. 10 shows a printer information table to be stored in the printer A. However, the method of determining the reference priority order to be established for each reference target printer is different from that of the printer information table shown in FIG. 7.

In other words, the reference priority order of each reference target printer is determined in the descending order of the value obtained by multiplying the degree of matching with the estimated cumulative processing time in case of FIG. 10. Said value is 0.5*120=60 for the printer B, 1*87=87 for the printer C, 1*70=70 for the printer D, and 0.33*200=66 for the printer E, so that the reference priority order is determined in the order of printers C, D, E and B.

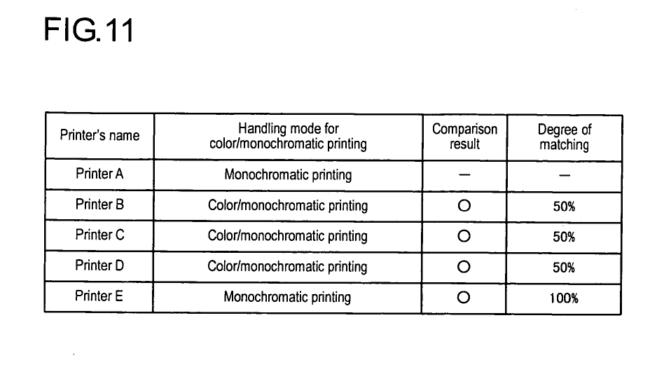

FIG. 11 shows yet another alternative example of the printer information table. In case of FIG. 11, the handling mode for color/monochromatic printing is obtained as a specification item of printers in this case.

As shown in FIG. 11, the handling mode for the printers A and E is monochromatic printing, while the handling mode for the printers B, C and D is color/monochromatic printing. Since there can be print jobs that are executable on the printer A among the print jobs that are executable on the printers B through E, the comparison result items on the printer information table all become“◯.” Since the printer A cannot print in color, the degree of matching concerning the handling mode of printers B, C and D relative to the printer A is 50% each. It is assumed here that equal numbers of color and monochromatic print jobs exist in this case.

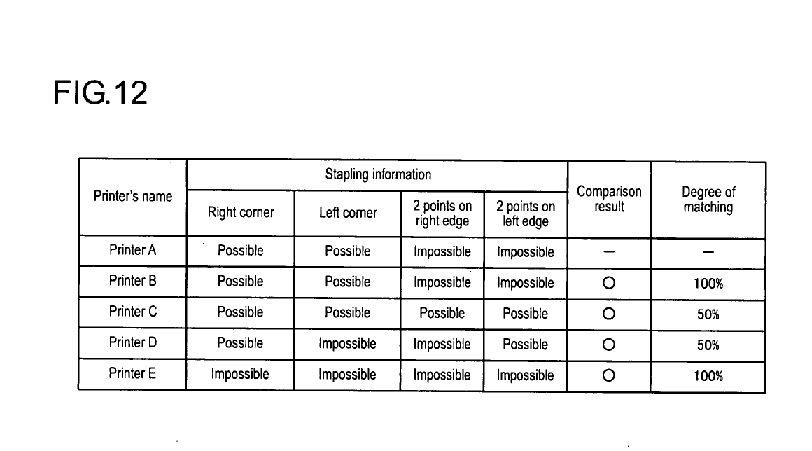

FIG. 12 shows yet another alternative example of the printer information table. In case of FIG. 12, finishing function information is obtained as a specification item of printers in this case. As an example of the finishing function information, stapling function information is obtained as information concerning a stapling process for stapling bundles of printed paper. Finishing function information concerning other finishing processes can also be obtained, for example, a punching process for punching holes on paper edges for a filing purpose.

As shown in FIG. 12, the stapling function information has four items of stapling location information. Since there can be print jobs that are executable on the printer A among the print jobs that are executable on the printers B through E, the comparison result items on the printer information table all become “◯.” Since the printer B is identical to the printer A in all four items of the stapling function information, the degree of matching concerning the stapling function information of the printer B relative to that of the printer A is 100%. On the other hand, since print jobs, whose stapling locations are specified to be two locations on the right edge or the left edge, among those that are executable on the printer C are not executable on the printer A, the degree of matching concerning the staple function information of the printer C relative to the printer A is set up to be 50%. Also, since print jobs, whose stapling locations are specified to be two locations on the left edge, among that are executable on the printer D are not executable on the printer A, the degree of matching concerning the staple function information of the printer D relative to the printer A is set up to be 50%. Since all four items of the printer E's stapling function information are “impossible,” all of the print jobs executable on the printer E are judged to be executable on the printer A, so that the degree of matching concerning the stapling function information of the printer E relative to that of the printer A is 100%. It is assumed that an equal number of print jobs exist for each item of the stapling function information.

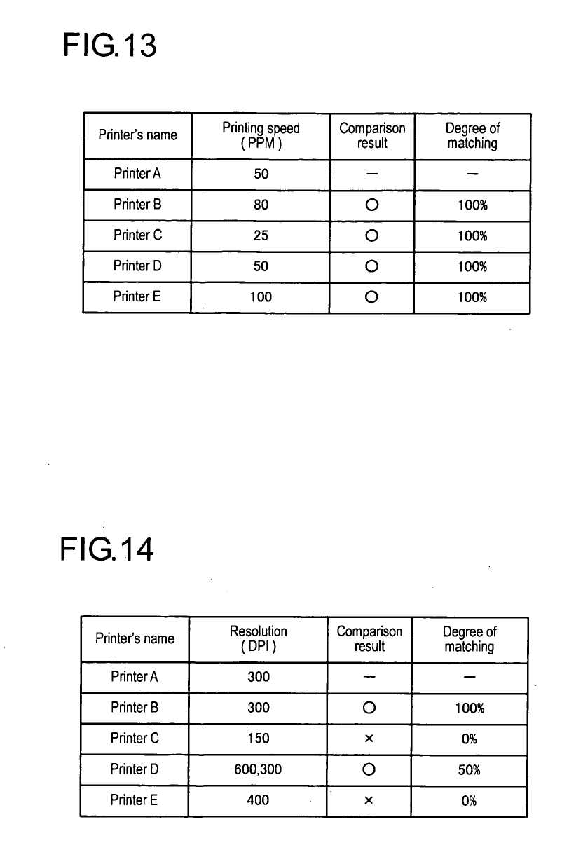

FIG. 13 shows yet another alternative example of the printer information table. In case of FIG. 13, printing speed is obtained as a specification item of printers in this case. The printing speed is expressed in terms of the number of pages per minute that can be printed (PPM: Page per Minute).

As shown in FIG. 13, print jobs executable on the printers B through E are also executable on the printer A, though at a different speed, so that all the comparison result items in the printer information table are set up to be “◯” and all the degrees of matching are set up to be 100%. However, it can also be constituted in such a way that the degree of matching changes with the printing speed. In this case, a calculation method that makes the degree of matching higher for a printer with a higher printing speed is used, if it is judged that there is a tendency that the workload of a printer with a higher printing speed tends to be higher as it attracts more print jobs. On the other hand, a calculation method that makes the degree of matching higher for a printer with a lower printing speed is used, if it is judged that lowering of the workload for a printer with a lower printing speed can contribute to the dispersion of the workload for the entire printing system.

FIG. 14 shows yet another alternative example of the printer information table. In case of FIG. 14, resolution is obtained as a specification item of printers in this case. The resolution is expressed for example by the number of dots per inch (DPI).

As shown in FIG. 14, the printer A can execute a print job whose resolution is specified as 300 DPI, so that the comparison items on the printer information table for the printers B and D become “◯.” Since the printer B and the printer A have the same resolution, the degree of matching of the printer B relative to the printer A is 100%. On the other hand, since print jobs, whose resolutions are specified to be 600 DPI, among those that are executable on the printer D are not executable on the printer A, the degree of matching concerning the resolution of the printer D relative to that of the printer A is set up to be 50%.

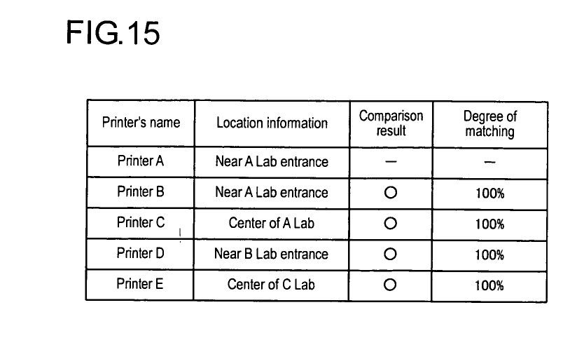

FIG. 15 shows yet another alternative example of the printer information table. In case of FIG. 15, location information is obtained as a specification item of printers in this case. The location information specifies the installation location of a printer.

As shown in FIG. 15, print jobs executable on the printers B through E are also executable on the printer A, though at a different location, so that all the comparison result items in the printer information table are set up to be “◯” and all the degrees of matching are set up to be 100%. However, the comparison result and/or the degree of matching can be set up to vary in accordance with the location information. For example, if it is judged that it may cause a burden to the user if a print job sent to the printer D is executed by a printer A instead, as the lab A is physically far away from the lab B, it can be so arranged as to set up the comparison result of the printer D to be “x” or the degree of matching to be low. However, it is necessary to have the criteria for these judgments to be preset on the printer A. More specifically, it is necessary to store a table with information about the physical distances between the printers or a map indicating the location of each printer in the printer A in advance and to preset the location requirements for printers to be used as reference targets. The network control unit 321 of the printer A calculates the comparison result and/or the degree of matching referencing the abovementioned preset values and conditions and registers them on the printer information table.

As described in the above, it is possible to eliminate other printers which have print jobs that its own printer A cannot execute at all from the potential list of referencing so as to minimize the number of reference object printers in advance as the printers to be used as targets of referencing are determined based on the specifications. This makes it possible to execute the transfer of a print job more efficiently and speedily.

As described before using FIG. 7, the reference priority order for reference target printers is determined in the descending order of the estimated cumulative processing time. In this case, the degree of matching does not affect the decision of the reference priority order. However, the reference priority order can be determined based not only on the estimated cumulative processing time but also on the degree of matching as described before using FIG. 10. If it is judged that the estimated cumulative processing time affects the efficiency of the referencing process more heavily than the degree of matching does, it is also possible to set the weight of the contribution of the estimated cumulative processing time on the determination of the reference priority order heavier than that of the degree of matching. Moreover, the reference priority order can be set considering only the degree of matching of the specification. Thus, since the reference priority order is determined for the reference target printers as such, the reference target printers can be more efficiently referenced.

The setup process of the reference priority order for the reference target printers can be skipped by simply limiting the number of the reference target printers based on the specifications. As an alternative, it is also possible to set up only the reference priority order for the reference target printers skipping the reference target printer limiting process based on the specifications. Minimization of the number of the reference target printers based on the specifications and setup of the reference priority order considering the degree of matching of the specifications are applicable not only in a case when the reference target printers are the printers to be referenced as the candidates for print job transfer sources, but also when the reference target printers are the printers to be referenced as the candidates for print job transfer destinations.

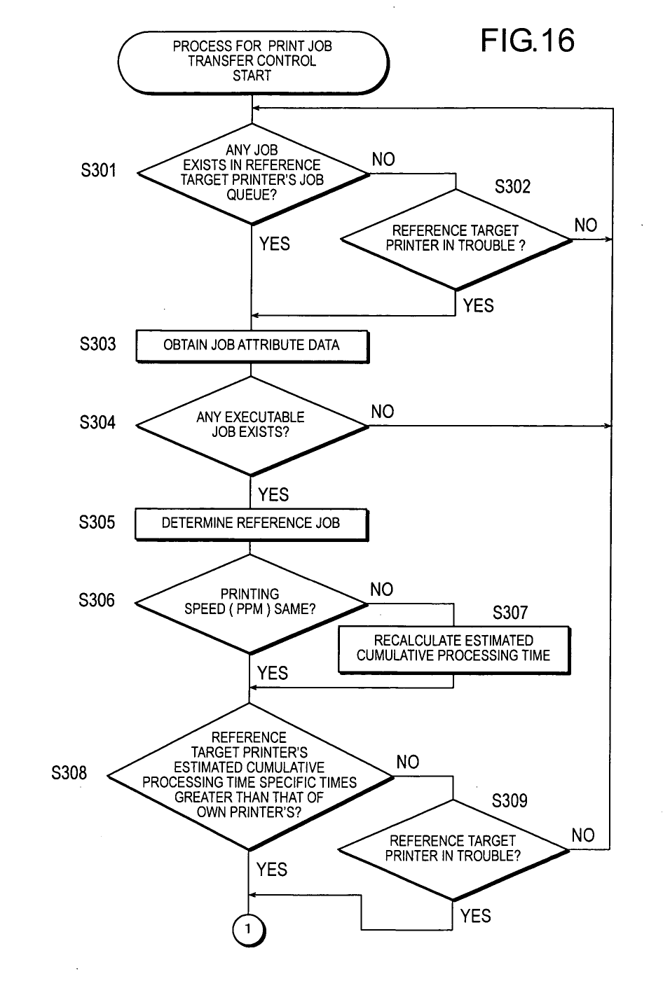

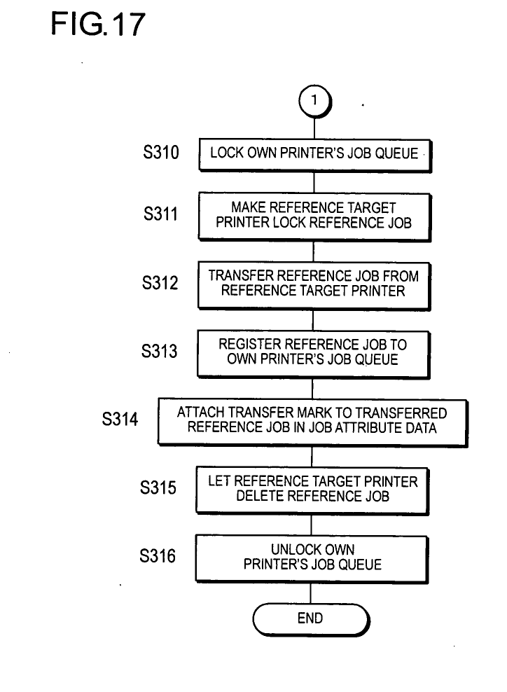

FIG. 16 and FIG. 17 represent a flowchart showing the sequence of the process for the print job transfer control. The algorithm shown in the flowcharts of FIG. 16 and FIG. 17 is stored as a program in the ROM 32 of the printer A and executed by the CPU 31. The process of FIG. 16 and FIG. 17 is executed by the job control unit 322 in this embodiment.

It is assumed that the process of determining the reference priority order for printers shown in FIG. 6 has been executed, so that the reference target printers and the reference priority order have already been determined.

First, a judgment is made as to whether a print job exists or not in the job queue 332 of a printer with the highest reference priority order (S301). A print job, which is set up to be executed based on a specific schedule, is stored in the job queue 332.

When a print job exists in the job queue 332 of the reference target printer (S301: Yes), the program advances to the step S303.

If no print job exists in the job queue 332 of the reference target printer (S301: No), a judgment is made as to whether the particular reference target printer is in a trouble such as out of paper or not (S302). When there is a trouble in a reference target printer (S302: Yes), the program advances to the step S303 to obtain print jobs from the particular reference target printer which is in trouble to execute them as much as possible.

In the step S303, a request for job attribute data is sent to the reference target printer and the job attribute data is received from the particular reference target printer (S303).

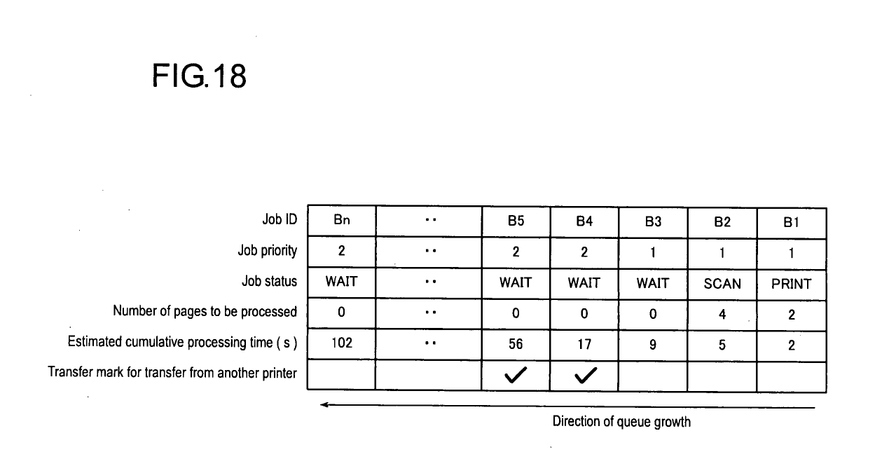

FIG. 18 is a diagram showing an example of job queue control data. The job queue control data for the printer B is shown here in a table format. The job queue control data includes job ID which is an identification code of a print job, job priority indicating the degree of priority in print job processing, job status indicating the current stage of print job processing, page number indicating the page being in process at the moment, estimated cumulative processing time, and transfer mark indicating that it is a print job transferred from another printer.

The job attribute data is generated and stored for each print job based on print jobs in the job queue 332, job queue control data, and the printer's specification. The job attribute data includes PDL type, paper size specification, color/monochromatic printing selection, finishing process designation, paper location designation, mark showing transfer from another printer, estimated cumulative processing time, and user information concerning the particular print job.

A judgment is made as to whether any print job that is executable by the printer A exists or not by referencing the obtained job attribute data in the step S304. A print job that carries a mark indicating that it is transferred from another printer is considered that it is not executable by the printer A so that it will not be transferred again for execution.

If no print job that is executable by the printer A exists (S304: No), the program returns to the step S301, and the process for the reference target printer of the next reference priority order is executed.

If there are any print jobs that are executable by the printer A (S304: Yes), a reference job that can be referenced as a candidate for transfer to its own printer A is determined among those print jobs that are executable by the printer A (S305). The print job referencing within the job queue 332 is done in the order of earliest request from the list of unexecuted print jobs.

A judgment is made as to whether the printing speed of the reference target printer has the same printing speed as its own printer A in the step S304 or not (S306).

If the printing speed of the reference target printer is the same as that of its own printer A (S306: Yes), a judgment is made as to whether the estimated cumulative processing time of the reference job on the reference target printer is a specified time higher or not than the estimated cumulative processing time of the reference job when executed by its own printer A (S308). Said specified time is normally set higher than one time, e.g., two times, but can be arbitrarily modified.

If the estimated cumulative processing time of the reference job on the reference target printer is a specified time higher than the estimated cumulative processing time of the reference job for executing it on its own printer A (S308: Yes), it is judged that some print jobs more convenient for transferring from the particular reference target printer to its own printer A exist, and the program advances to the step S310.

On the other hand, if the printing speed of the reference target printer is different from the printing speed of its own printer A (S306: No), the estimated cumulative processing time for executing the reference job on its own printer A is recalculated based on the printing speed of its own printer A and the waiting time of the job queue 332 (S307), and the program advances to the step S308.

If the estimated cumulative processing time of the reference job on the reference target printer is not a specified time higher than the estimated cumulative processing time of the reference job when it is executed on its own printer A (S308: No), it is judged that no print jobs more convenient for transferring from the particular reference target printer to its own printer A exists, and the program advances to the step S309. A judgment is made as to whether the reference target printer is in trouble or not in the step S309. When the reference target printer is in trouble (S309: Yes), the program advances to the step S310 to obtain print jobs from the particular reference target printer which is in trouble to execute them as much as possible.

In the step S310, the job queue 332 of its own printer A is locked. This prevents the job queue 332 of its own printer A from being referenced by another printer.

Next, the job control unit 322 controls the reference target printer to lock the reference job being currently referenced (S311), and transfers the particular reference job from the reference target printer to its own printer A (S312).

The reference job transferred to its own printer A is registered to the job queue 332 of its own printer A (S313).

A transfer mark will be added to the transferred reference job on the job attribute data for its own printer A (S314).

The job control unit 322 controls the reference target printer to delete the already transferred reference job from the job queue of the reference target printer (S315).

Next, the job queue 332 of its own printer A is unlocked (S316). This makes the job queue 332 of its own printer A capable of being referenced by another printer.

The printer of this embodiment controls by receiving load information from another printer, comparing the load resulting from print jobs on the other printer with the load resulting from print jobs on its own printer, and transferring a print job from the other printer to its own printer based on the comparison result.

Therefore, it is capable of allowing a lightly loaded printer to obtain a print job from a heavily loaded printer, thus preventing a heavily loaded printer from further being loaded with an additional job for the sake of the load distribution process. This makes it possible to distribute loads caused by print jobs to a plurality of printers more efficiently.

Moreover, since it does not require a special device to distribute print jobs to lightly loaded printers, it can minimize the installation space and equipment cost.

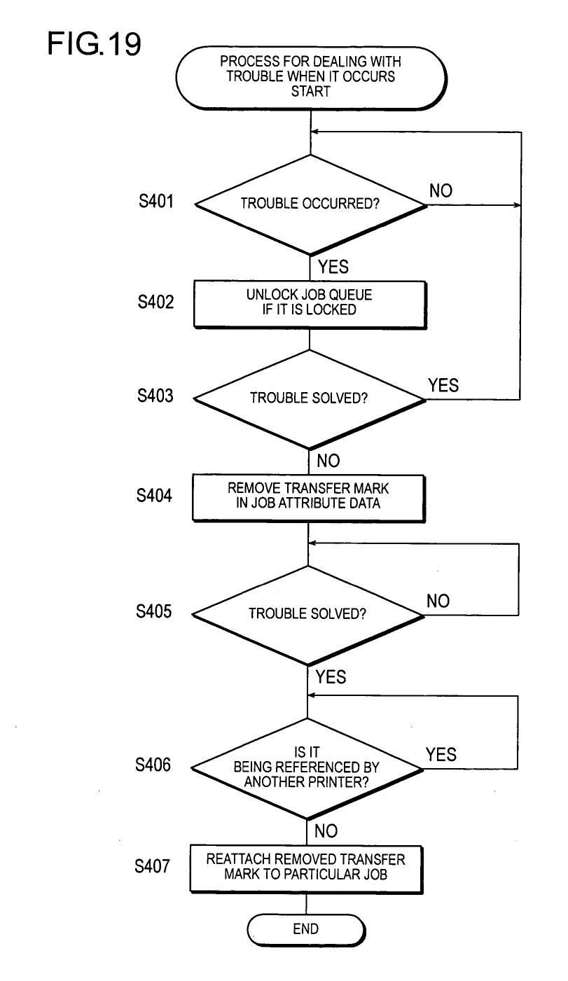

FIG. 19 is a flowchart showing the sequence of the process for dealing with a trouble when it occurs. The algorithm shown in the flowchart of FIG. 19 is stored as a program in the ROM 32 of the printer A and executed by the CPU 31. The process of FIG. 19 is executed by the job control unit 322 in this embodiment.

The job control unit 322 monitors troubles such as out-of-paper problem that can hinder smooth execution of print jobs (S401: No).

When a trouble occurs (S401: Yes), the job queue 332 of its own printer A is unlocked if it is locked (S402) to make it possible to be referenced from other printers. In other words, it becomes possible to accept transfer requests from other printers.

Next, a judgment is made as to whether it is recovered or not from the trouble (S403). When it is recovered from the trouble (S107: Yes), the program returns to step S401.

If it has not recovered from the trouble (S403: No), the transfer mark attached to the transferred print job on the job attribute data of its own printer A is removed (S404).

Next, it waits for its recovery from the trouble (S405: No). When it is recovered from the trouble (S405: Yes), a judgment is made as to whether it is referenced or not by another printer (S406). If it is referenced by another printer, it waits until it becomes no longer referenced by the other printer (S406: Yes).

If it is not reference by another printer (S406: No), the transfer mark that was removed in the step S404 is reattached to the particular print job (S407).

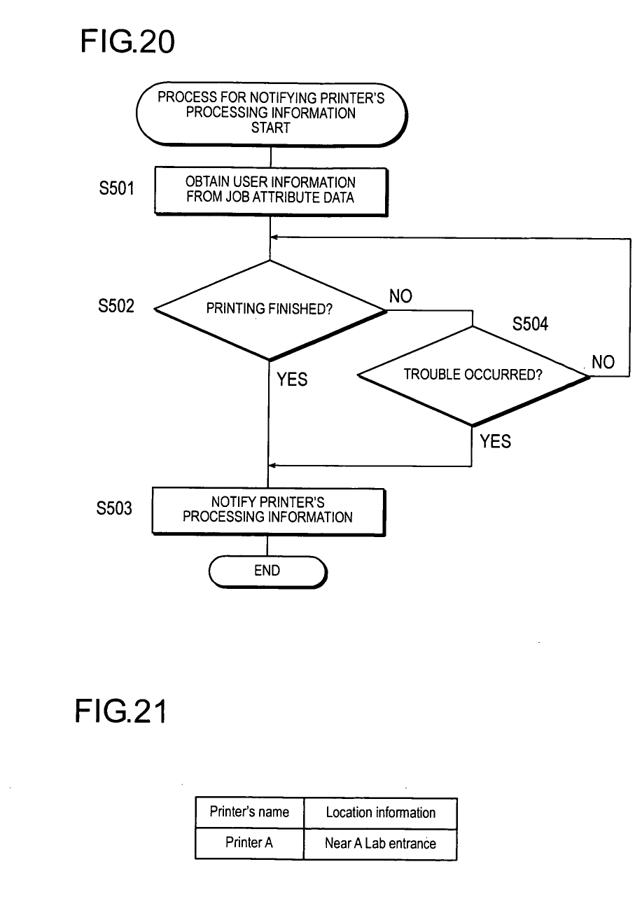

FIG. 20 is a flowchart showing the sequence of the process for notifying the printer's processing information. The algorithm shown in the flowcharts of FIG. 20 is stored as a program in the ROM 32 of the printer A and executed by the CPU 31.

First, the job control unit 322 obtains the user information from the job attribute data concerning the currently processed print job, which has been transferred (S501). The user information contains the name and the IP address of the client terminal that issued the print job. Whether it is a print job transferred from other printers or not can be judged by the transfer mark.

The job control unit 322 makes a judgment whether the printing process based on the particular print job is completed or not in the step S502.

If the printing process has not been completed (S502: No), a judgment is made as to whether any trouble exists or not in its own printer A (S504). If no trouble exists (S1504: No), the program returns to step S502.

If the printing process has been completed (S502: Yes), or if a trouble exists (S504: Yes), the program advances to the step S503.

The printer's processing information is transmitted to the user's client terminal in the step S503.

More specifically, the job control unit 322 first notifies the main control unit 323 with the user information and the output status concerning the particular print job. The output status includes a report that a normal printing output is generated based on a print job, type of error when a trouble occurs, etc. The main control unit 323 obtains the name and location information of the printer A from the printer's location information table, and transmits the name and location information of the printer A as well as the abovementioned user information and output status concerning the print job to the network control unit 321.

FIG. 21 shows an example of the printer location information table. The printer location information table is registered in each printer in advance and contains the name and the location information of the printer. The location information can be written in any expression format as long as the user can identify the printer's location by it. The network control unit 321 obtains the IP address from the user information and transmits the printer's processing information including the name and location information of the printer A as well as the output status to the client terminal with the particular IP address.

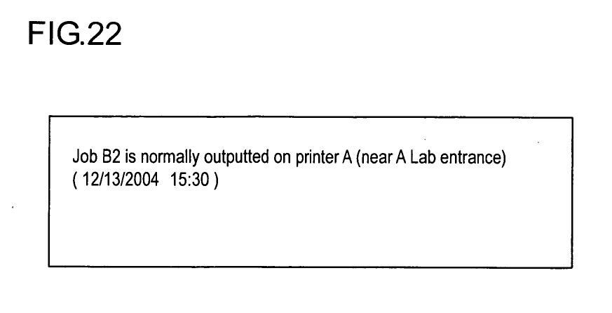

The printer's processing information is transmitted more specifically to the location notifying software preinstalled in the client terminal. Upon receiving the notification, the location notifying software prepares a notification window such as the one shown in FIG. 22 and displays the notification window on a display device (not shown) of the client terminal.

It is also possible to constitute the system in such a way as to transmit the printer's processing information to the printer which received the particular print job first, and display the notification window such as shown in FIG. 22 on the operating panel unit 35. This enables the user to find out the location of the printer at which printing actually occurs when the user goes to the location of the printer which was originally planned to be used for the printing.

The process of notifying such a printer processing information can be accomplished by doing it only at the printer where the actual printing output is generated even if the transfer of the print job occurs. In other words, printers other than the printer actually involved in printing do not have to be involved in the notification process, thus providing an advantage that not only the process becomes simpler, but also the user can recognize the printer involved in printing more easily.

In this embodiment, the notification process of the printer's processing information is performed by the printer A when printing is executed based on the print job transferred from another printer to its own printer A. However, it can also be configured in such a way as to make the printer A to be in charge of the notification process of the information concerning the transfer of a print job when the print job is transferred from its own printer A to another printer. In this case, the information concerning the transfer of the print job includes the name and location information of the printer of the transfer destination.

The notification process of the printer's processing information shown in FIG. 20 can be omitted if the particular print job is executed by a printer which received it first as originally planned.

As described in the above, the present invention makes it possible to allow an own image processing device to make a judgment as to whether it is more desirable to process a print job assigned to another image processing device on its own image processing device and to execute the process of obtaining the particular print job based on the judgment result, thus making it possible to prevent an already overloaded image processing device from further burdened by the load distribution process. This makes it possible to distribute loads to a plurality of image processing devices more efficiently.

Moreover, since it does not require a special device to distribute print jobs to lightly loaded image processing devices, it can minimize the installation space and equipment cost.

It is obvious that this invention is not limited to the particular embodiments shown and described above but may be variously changed and modified without departing from the technical concept of this invention.

For example, the present invention can be applied to a printing system where printers receive print jobs from the client terminal 1 through a print server. Furthermore, the present invention can be applied to a print server for such a printing system. In this case, the print server can obtain information such as specification form each printer connected to the particular print server and decide whether each printer is a printer to be referenced as a transfer source or destination candidate for a print job or not.

Also the present invention can be applied to a cluster printing system where a print server receives a print job from the client terminal 1 and make a plurality of printers to print in parallel. Furthermore, the present invention can be applied to a print server for such a cluster printing system as well. In this case, the print server can obtain information such as specifications of a plurality of printers connected to another print server from the particular print server. The specifications of the printers connected to each print server can be compared by the printers themselves.

It is also possible to use, in place of a printer, a facsimile machine, a copying machine, or an MFP (multi-function peripheral) that has a combination of their functions as an image processing device of the present invention.

The means and method of conducting various processes in the printer as an image processing device according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a storage unit such as a hard disk. Said program can also be provided as independent application software or can be built into the software of the image processing device as a part of its function.

What is claimed is:

1. An image processing device capable of communicating with another image processing device via a network, comprising:
a communication unit for communicating with the other image processing device; and
a controller for making a judgment based on information concerning a print job on the other image processing device obtained through the communication unit as to whether it is preferable or not to execute the print job on its own image processing device rather than to execute the print job on the other image processing device, and transferring the print job from the other image processing device to its own image processing device depending on the judgment result.

2. An image processing device as claimed in claim 1, wherein:
said controller makes said judgment by comparing the other image, processing device's load and its own image processing device's load.

3. An image processing device as claimed in claim 2, wherein
said own image processing device's load includes the load arising from the print job intended to be transferred from the other image processing device to its own image processing device.

4. An image processing device as claimed in claim 2, wherein
said controller obtains said information from a plurality of other image processing devices respectively via said communication unit and executes said comparison in the priority order based on the size of load of each of said plurality of other image processing devices.

5. An image processing device as claimed in claim 4, wherein
said information includes specification information concerning the other image processing device's specification;
said controller executes said comparison further in consideration of the degree of matching between each of the specifications of said plurality of other image processing devices and the specification of its own image processing device.

6. An image processing device as claimed in claim 5, wherein
said controller omits execution of said comparison for another image processing device having a specification that does not match with its own image processing device's specification.

7. An image processing device as claimed in claim 5, wherein
said specification includes at least either one of page description language that can be processed, paper size, handling mode for color/monochromatic printing, finishing function information, printing speed, resolution, and installation location information.

8. An image processing device as claimed in claim 1, wherein
said controller notifies processing information concerning said print job's process when there is a transfer of a print job between its own image processing device and another image processing device.

9. An image processing device as claimed in claim 8, wherein
said processing information includes information concerning execution of printing based on the print job transferred from another image processing device to its own image processing device.

10. An image processing device as claimed in claim 9, wherein
said processing information includes location information of its own image processing device.

11. An image processing device as claimed in claim 8, wherein
said processing information includes the information that a print job is transferred from its own image processing device to another image processing device.

12. An image processing device as claimed in claim 11, wherein
said processing information includes location information of the transfer destination image processing device.

13. An image processing device as claimed in claim 8, wherein
said controller transmits said processing information to at least either one of a client terminal and the other image processing device via said communication unit.

14. An image processing method using an image processing device capable of communicating with another image processing device via a network, comprising the steps of:
1) receiving information concerning a print job on the other image processing device from the other image processing device;
2) making a judgment based on the information received in the step 1) as to whether it is preferable to execute the print job on its own image processing device rather than to execute the print job on the other image processing device; and
3) controlling to transfer the print job from the other image processing device to its own image processing device depending on the judgment result in the step 2).

15. A computer readable recording medium stored with an image processing program for controlling an image processing device capable of communicating with another image processing device via a network, said image processing program causing the image processing device to execute a process comprising the steps of:
1) receiving information concerning a print job on the other image processing device from the other image processing device;
2) making a judgment based on the information received in the step 1) as to whether it is preferable to execute the print job on its own image processing device rather than to execute the print job on the other image processing device; and
3) controlling to transfer the print job from the other image processing device to its own image processing device depending on the judgment result in the step 2).
